(19) United States
(12) Patent Application Publication
(10) Pub. No.: US 2003/0081278 A1
(43) Pub. Date: May 1, 2003

(54) Optical module testing method and testing system

(75) Inventors: Norio Chujo, Tokyo (JP); Kosuke Inoue, Fujisawa (JP); Tomoaki Shimotsu, Yokohama (JP); Atsushi Hasegawa, Yokohama (JP); Takeshi Yamashita, Yokohama (JP); Hideyuki Kuwano, Yokohama (JP); Ryozo Sato, Yokohama- (JP); Katsumi Uchida, Fujisawa (JP); Ikuo Kawaguchi, Tokyo (JP); Kyouichi Yamamoto, Yokohama (JP); Takashi Minato, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: OpNext Japan, Inc., Yokohama-shi (JP)

(21) Appl. No.: 10/115,918

(22) Filed: Apr. 2, 2002

(30) Foreign Application Priority Data
Nov. 1, 2001 (JP) 2001-336190

(51) Int. Cl. H04B 10/08

(52) U.S. Cl. 359/110

(57) ABSTRACT

While modules to be tested in one constant temperature oven are tested by providing a plurality of constant temperature ovens, accommodating a plurality of modules to be tested in each constant temperature oven and connecting the modules to be tested accommodated in a plurality of constant temperature ovens to the measuring instruments via the switches, preparation for testing such as temperature change of the other constant temperature oven is conducted and the modules to be tested in one constant temperature oven are tested using measuring instruments. Thereafter, the switches are changed over and the modules to be tested accommodated in the other constant temperature oven are tested. Thereby, expensive measuring instruments can be used effectively.

### FIELD OF THE INVENTION

The present invention relates to a testing method and a testing system of an optical module for converting an electrical signal to an optical signal and converting an optical signal to an electrical signal.

### DESCRIPTION OF THE RELATED ART

A testing apparatus has been constructed as shown in FIG. 4 for testing a code error rate for the receiving power of an optical module with an error detector (ERD).

FIG. 4 is a block diagram showing a testing system of an optical module of the related art. A pulse pattern generator (hereinafter abbreviated as PPG) 2 is operated with a clock outputted from a clock generator (hereinafter referred to as CLK generator) to output a pulse pattern. The pulse pattern which is an electrical signal from the PPG 2 is converted to an optical signal in the standard optical transmitting module 3a, it is then attenuated in an attenuator (hereinafter abbreviated as ATT) 4a and thereafter inputted to an optical receiving module 7 to be tested. The optical receiving module 7 to be tested is accommodated within a constant temperature oven 6. This optical receiving module 7 to be tested is tested at the predetermined higher temperature and the predetermined low temperature. Therefore, a temperature sensor 11 is provided in the constant temperature oven 7 and thereby the temperature in the constant temperature oven is controlled by a controller 10. An output of the optical receiving module to be tested 7 is inputted to the ERD 9a to test the code error rate. The controller 10 controls a pulse pattern and an output voltage obtained by controlling the PPG 2, also controls amount of attenuation by the ATT 4a and reads the error rate measured with the ERD 9a.

The receiving module 7 to be tested is tested under various conditions where the temperature of the constant temperature oven 6 is set to the predetermined low temperature or to the predetermined high temperature or to the normal temperature.

FIG. 5 is a characteristic diagram showing temperature management of the constant temperature oven in the testing system of the related art. Time is plotted on the horizontal axis, while temperature of the constant temperature oven on the vertical axis. In this figure, during the period from the time t1 to time t2, the constant temperature oven 6 is not in the temperature control and the constant temperature oven 6 is kept at the normal temperature T1 and the optical receiving module 7 to be tested is tested in this condition. During the period from the time t2 to time t3, temperature of the constant temperature oven 6 is lowered and is controlled to the predetermined temperature T2. During the period from the time t3 to time t4, the constant temperature oven 6 is kept at the predetermined low temperature T2 and the optical receiving module 7 is tested. Upon completion of the test, temperature of the constant temperature oven is controlled during the period from the time t4 to time t5 in order to set the constant temperature oven 6 to the predetermined high temperature T3. When temperature of the constant temperature oven 6 rises up to the preset high temperature T3 at the time t5, the optical receiving module 7 is tested during the period from the time t5 to time t6. During the period from the time t6 to time t7, temperature of the constant temperature oven 6 is varied.

In the prior art explained above, since one optical receiving module 7 to be tested is accommodated within one constant temperature oven 6, the optical receiving module 7 to be tested cannot be tested and the time is wasted during the period when the temperature of the constant temperature oven is controlled, namely during the periods from the time t2 to time 3, from the time t4 to time t5 and from the time t6 to time t7. Moreover, the PPG 2 and ERD 9a have respectively been used in such numbers as many as the number of optical receiving modules 7 to be tested at a time, but since the PPG 2 and ERD 9a are every expensive and it is preferable that the numbers of PPGs 2 and ERDs 9a are reduced to assure the effective use thereof.

### SUMMARY OF THE INVENTION

An object of the present invention is to provide a testing technique to test a plurality of optical receiving modules to be tested in the higher efficiency.

In order to achieve the object of the present invention, an optical module testing method as a first invention comprises the steps of accommodating a first module to be tested within a first constant temperature oven, accommodating a second module to be tested within a second constant temperature oven and testing the first module to be tested accommodated within the first constant temperature oven and the second module to be tested accommodated within the second constant temperature oven through the change-over operation.

In the first invention, the first and second modules to be tested are optical receiving module and an error detector is used for the test. Or, the first and second modules to be tested are optical transmitting modules and this test is conducted by using any one of optical sampling oscilloscope, optical spectrum analyzer and error detector. Otherwise, the first and second modules to be tested are LD (Laser Diode) module and the test is conducted by using at least any one of IL meter, optical spectrum analyzer, optical power meter, RIN meter.

An optical module testing method as the second invention comprises the steps of generating a pulse pattern of an electrical signal based on the clock, converting the pulse pattern to an optical signal, attenuating the pulse pattern converted to the optical signal, supplying selectively the attenuated pulse pattern to the first optical receiving module to be tested accommodated in the first constant temperature oven and to the second optical receiving module to be tested accommodated in the second constant temperature oven and testing the code error rate of the first and second optical receiving module to be tested through the change-over operation.

In the second invention, a step for testing the characteristic against jitter is also provided.

An optical module testing system as a third invention comprises a first constant temperature oven, a first module to be tested accommodated within the first constant temperature oven, a second constant temperature oven, a second module to be tested accommodated within the second constant temperature oven, a switch for selecting the first module and the second module to be tested and a measuring instrument to be used for testing the first and second modules to be tested.

In the third invention, the first and second modules to be tested are optical receiving modules and the measuring instrument is an error detector. Otherwise, the first and second modules to be tested are optical transmitting modules and a measuring instrument is one or more instruments selected from optical sampling oscilloscope, optical spectrum analyzer and error detector. Or, the first and second modules to be tested are LD module and the test is conducted using at least one or more instruments selected from IL meter, optical spectrum analyzer, optical power meter and RIN meter.

An optical module testing system as a fourth invention comprises a pulse pattern generator for generating a pulse pattern of an electrical signal based on the clock, an E/O converter for converting the pulse pattern to an optical signal, an attenuator for attenuating the pulse pattern converted to the optical signal, a first constant temperature oven, a second constant temperature oven, a first optical receiving module to be tested accommodated within the first constant temperature oven, a second optical receiving module to be tested accommodated in the second constant temperature oven, a switch for supplying selectively an output of the attenuator to the first optical receiving module to be tested and the second optical receiving module to be tested, an error detector and a switch for connecting selectively the first and second optical receiving modules to be tested to the error detector.

In the fourth invention, a jitter analyzer is also provided to test the characteristic against jitter.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a block diagram showing a first embodiment of the optical receiving module testing system of the present invention.

FIG. 2 is a characteristic diagram showing temperature management of a constant temperature oven in the optical receiving module testing system of the present invention.

FIG. 3 is a flowchart showing an embodiment of the processing operations of the testing system shown in FIG. 1.

FIG. 4 is a block diagram showing an optical module testing system of the related art.

FIG. 5 is a characteristic diagram showing temperature management of the constant temperature oven in the testing system of the present invention.

FIG. 6 is a characteristic diagram showing a code error rate of the minimum receiving sensitivity.

FIG. 7 is a block diagram showing a second embodiment of the optical receiving module testing system of the present invention.

FIG. 8 is a block diagram showing a third embodiment of the optical receiving module testing system of the present invention.

FIG. 9 is a block diagram showing a fourth embodiment of the optical receiving module testing system of the present invention.

FIG. 10 is a block diagram showing a first embodiment of the optical transmitting module testing system of the present invention.

FIG. 11 is a schematic diagram for explaining testing procedures of the optical transmitting module to be tested.

FIG. 12 is a block diagram showing a first embodiment of an LD module testing system of the present invention.

### DESCRIPTION OF THE PREFERRED EMBODIMENTS

The preferred embodiments of the present invention will be explained with reference to the accompanying drawings.

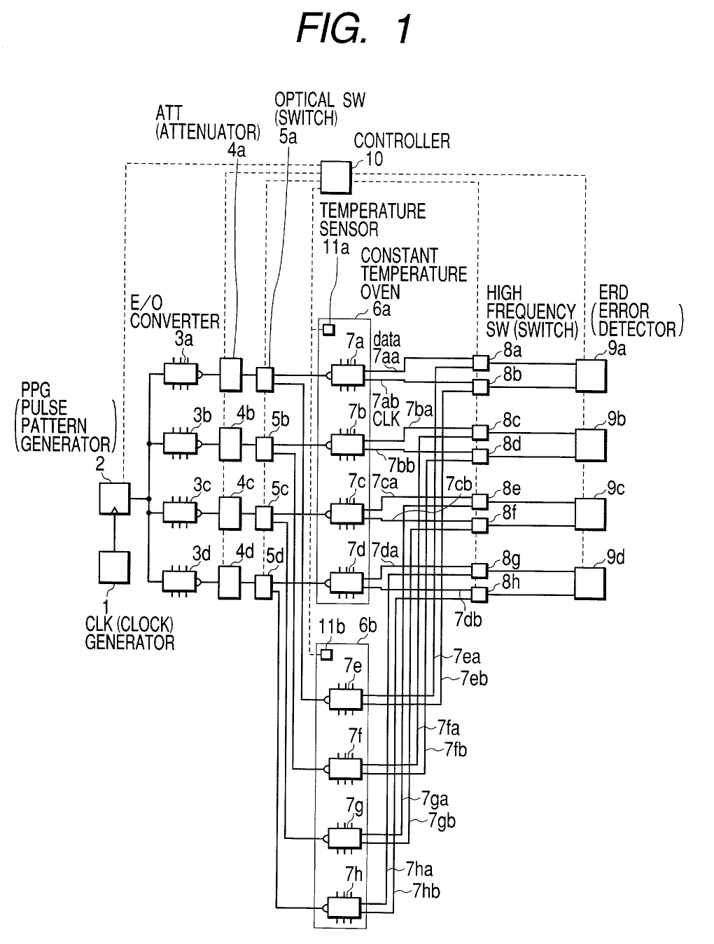

FIG. 1 is a block diagram showing a first embodiment of the optical receiving module testing system of the present invention. In the testing system of the figure, one pulse pattern generator (PPG) 2, four error detectors (ERD) 9a to 9d and two constant temperature ovens 6a, 6b are provided, four optical receiving modules 7a to 7d to be tested are accommodated within a first constant temperature oven 6a and four optical receiving modules 7e to 7h are accommodated within a second constant temperature oven 6b. The PPG 2 is controlled with the clock generated by the CLK generator 1 to generate a pulse pattern, an electrical signal of this pulse pattern is converted to an optical signal by the E/O converters 3a to 3d formed of standard optical transmitting modules or the like, the optical signal is then attenuated by attenuators ATT 4a to 4d and is then inputted to optical switches 5a to 5d. Outputs of the ATT 4a to 4d are selectively supplied to the optical receiving modules 7a to 7d to be tested accommodated in the first constant temperature oven 6a or to the optical receiving modules 7e to 7h to be tested accommodated in the second constant temperature oven 6b by optical switches 5a to 5d. The optical receiving modules 7a to 7d or 7e to 7h to which outputs of the ATT 4a to 4d are supplied are output the data 7aa to 7da or data 7ea to 7ha to the outputs thereof and also output the clocks (CLK) 7ab to 7db or 7eb to 7hb reproduced from the data. The data 7aa, 7ea of the optical receiving modules 7a, 7e to be tested are supplied to a high frequency switch 8a, while the clocks 7ab, 7eb of the optical receiving modules 7a, 7b to be tested are supplied to a high frequency switch 8b. In the same manner, the data 7ba, 7fa of the optical receiving modules 7b, 7f to be tested are supplied to the high frequency switch 8c, while the clocks 7bb, 7fb of the optical receiving modules 7b, 7f to be tested to the high frequency switch 8d. Moreover, the data 7ca, 7ga of the optical receiving modules 7c, 7g to be tested are supplied to a high frequency switch 8e, while the clocks 7cb, 7gb of the optical receiving modules 7c, 7g to be tested to a high frequency switch 8f. Moreover, the data 7da, 7ha of the optical receiving modules 7d, 7h to be tested are supplied to a high frequency switch 8g, while the clocks 7db, 7hb of the optical receiving modules 7d, 7h to be tested to a high frequency switch 8h. In addition, in the figure, a controller 10 controls a pulse pattern of the PPG 2 and an output voltage thereof. Moreover, temperature of the first and second constant temperature ovens 6a, 6b is controlled based on the temperature from temperature sensors 11a, 11b provided in the first and second constant temperature ovens 6a, 6b. Amount of attenuation of the ATTs 4a, 4b is varied at the predetermined temperature and the signals are then supplied to the optical receiving modules 7a to 7h to be tested and moreover the amount of attenuation of the ATTs 4a to 4d are controlled with the controller 10 in order to measure a code error rate of each receiving power in the ERDs 9a to 9d. In addition, the controller 10 controls the switching of the optical switches 5a to 5d and controls the temperature of the constant temperature ovens 6a, 6b to the temperatures of preset several levels such as normal temperature, low temperature and high temperature, etc. Moreover, the controller 10 controls the switching of the high frequency switches 8a to 8h and further reads the code error rates measured with the ERDs 9a to 9d.

In this embodiment, since a couple of constant temperature ovens, namely the first and second constant temperature ovens 6a, 6b are provided, when the optical receiving modules 7a to 7d to be tested are being tested in the first constant temperature oven 6a, temperature of the second constant temperature oven 6b may be changed or the optical receiving module to be tested in the constant temperature oven 6b can be exchanged. In addition, since temperature of the first constant temperature oven may be changed or the optical receiving module to be tested in this first constant temperature oven can be exchanged while the four optical receiving modules 7e to 7h to be tested in the second constant temperature oven 6b are being tested, the PPG 2 and ERDs 9a to 9d can be used effectively. Namely, in this testing system, the PPG 2 and ERDs 9a to 9d are considerably expensive, but in this system, since the PPG 2 and ERDs 9a to 9d are always testing the optical receiving modules in any one of the constant temperature ovens 6a, 6b, a non-testing time which has been generated when temperature of the constant temperature oven is varied can be reduced (up to 0 when the temperature changing time of the constant temperature oven is set equal to the testing time) and thereby the throughput in the optical receiving module test can be enhanced. Therefore, on the occasion of testing a certain number of optical receiving modules, the number of testing devices can be reduced from that used in the existing testing system and thereby testing cost can also be reduced.

Here, it is also preferable that the number of constant temperature ovens is set so that the temperature changing time of the constant temperature ovens 6a, 6b comes as much close to the testing time. For example, when the testing time is equal to a half (½) of the temperature changing time of the constant temperature oven, it is enough to set the number of constant temperature ovens to 3. The number of optical receiving modules to be tested accommodated within the constant temperature oven can be optimized depending on the number of modules to be tested within a certain time and cost of each apparatus required for the testing system such as ERD or the like.

In order to conduct the SX test with this optical receiving module testing system, a variable wavelength optical source is additionally provided to this system and an output thereof is mixed into the standard outputs of the E/O converters 3a to 3d by providing a couple between the E/O converters (standard optical transmitting modules) 3a to 3d and the attenuators ATTs 4a to 4b. Moreover, it is also possible that another ATT and an optical amplifier are connected between the standard E/O converters 3a to 3d and the ATTs 4a to 4b to conduct the test including the ASE noise test. Moreover, it is also possible to conduct the tests where the ASE noise is added or not added using an optical switch.

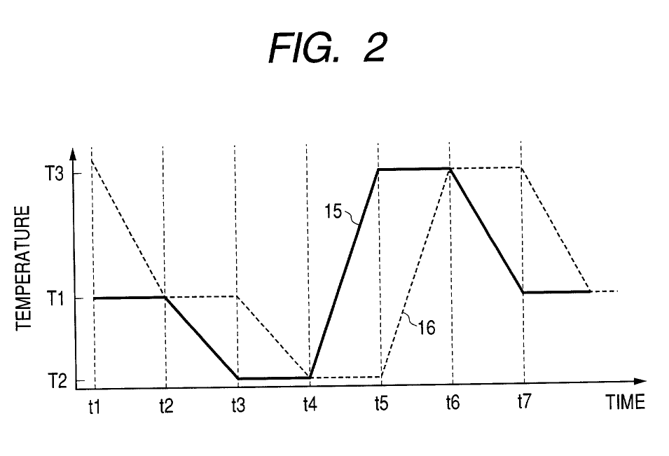

Next, temperature management of the first and second constant temperature ovens will be explained with reference to FIG. 2.

FIG. 2 is a characteristic diagram showing temperature management of a constant temperature oven used in the optical receiving module testing system of the present invention. In this figure, time is plotted on the horizontal axis, while temperature of constant temperature oven on the vertical axis. In FIG. 2, the numeral 15 indicates the temperature characteristic line of the first constant temperature oven 6a, while numeral 16 indicates the temperature characteristic line of the second constant temperature oven 6b.

In this embodiment, the optical receiving modules to be tested 7a to 7d or 7e to 7h are generally tested under the three temperature conditions of room temperature, high temperature and low temperature. Therefore, during the period from the time t1 to time t2, the optical receiving modules to be tested 7a to 7d accommodated within the first constant temperature oven 6a are tested under the room temperature T1. Moreover, during this period, temperature of the second constant temperature oven 6b is transitioned toward the next temperature. When the test of the optical receiving modules to be tested 7a to 7d under t5 the ordinary room temperature T1 of the first constant temperature oven 6a at the time t2 is completed, the temperature of the first constant temperature oven 6a is lowered. Simultaneously, the optical receiving modules to be tested 7a to 7d are tested under the room temperature T1 in the second constant temperature oven 6b. At the time t3, the temperature of the first constant temperature oven 6a reaches the temperature for the low temperature test and simultaneously the test of the optical receiving modules to be tested 7e to 7h under the room temperature T1 in the second constant temperature oven 6b is also completed, the test of the optical receiving modules to be tested 7a to 7d under the low temperature T2 in the first constant temperature oven 6a is started and the temperature of the second constant temperature oven 6b is lowered. As explained above, during the period from the time t3 to time t4, the optical receiving modules to be tested 7a to 7d under the low temperature T2 in the first constant temperature oven 6a are tested and during the period from the time t4 to time t5, the optical receiving modules to be tested 7e to 7h under the lower temperature T2 in the second constant temperature oven 6b are tested. During the period from the time t5 to time t6, the optical receiving modules to be tested 7a to 7d under the high temperature T3 in the first constant temperature oven 6a are tested and during the period from the time t6 to time t7, the optical receiving modules to be tested 7e to 7h under the high temperature T3 in the second constant temperature oven 6b are tested. As explained above, the PPG 2 and ERDs 9a to 9d of the optical receiving module testing system shown in FIG. 1 are always testing the optical receiving modules in any one of the constant temperature ovens.

Next, processing operations for the test of optical receiving modules to be tested in regard to the first embodiment of FIG. 1 will be explained.

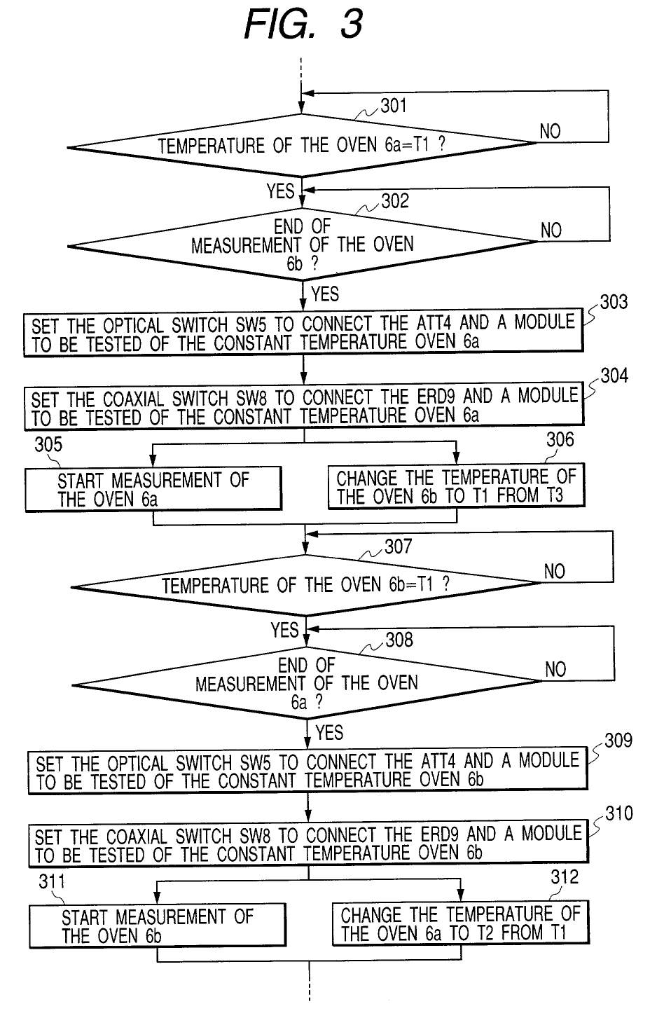

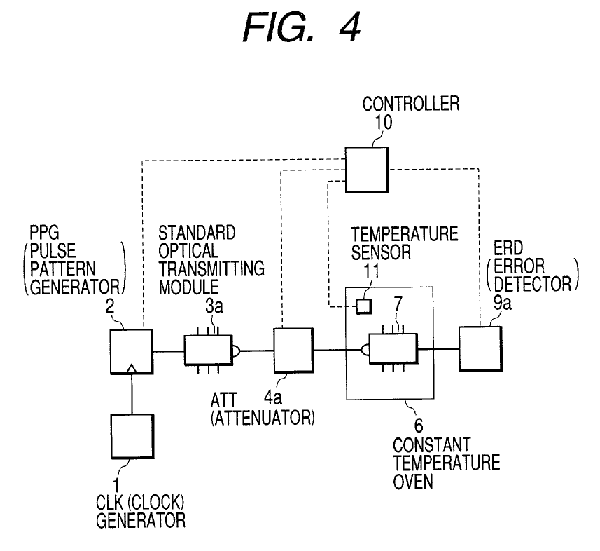

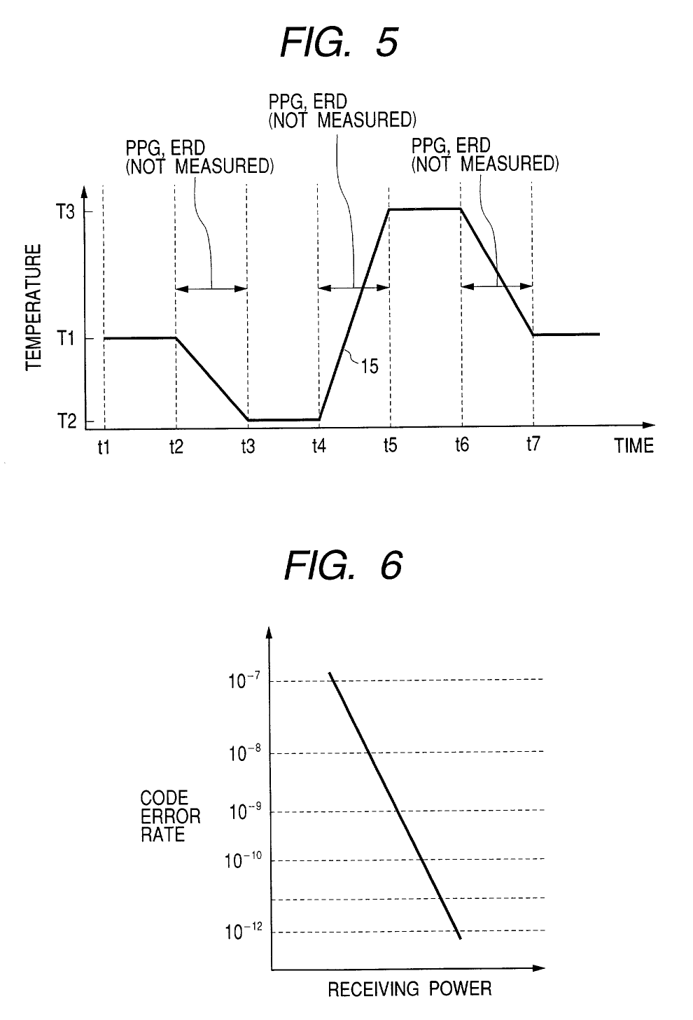

FIG. 3 is a flowchart showing an embodiment of the processing operations of the testing system of FIG. 1. In the step 301, it is judged whether the temperature of the first constant temperature oven 6a is set to an ordinary room temperature (normal temperature) T1 or not. If the temperature is not set to the ordinary room temperature, the testing system is set to the waiting condition until the temperature reaches the room temperature. When the temperature reaches the room temperature T1, it is judged in the step 302 whether measurement in the second constant temperature oven 6b is completed or not. When measurement is completed, the process shifts to the step 303. In the step 303, the optical switches 5a to 5d are controlled to connect the ATTs 4a to 4d and optical receiving modules to be tested 7a to 7d. Thereafter, in the step 304, the high frequency switches (coaxial switches) 8a to 8h are controlled to connect the optical receiving modules to be tested 7a to 7d and the ERDs 9a to 9d. In the step 305, measurement of the optical receiving modules to be tested 7a to 7d in the first constant temperature oven 6a is started and simultaneously the controller 10 controls the temperature in the second constant temperature oven 6b to change to the ordinary room temperature T1 from the high temperature T3 in the step 306. When the temperature of the second constant temperature oven 6b becomes T1 in the step 307 and the test of the optical receiving modules to be tested 7a to 7d in the first constant temperature oven 6a is completed in the step 308, the optical switches 5a to 5d are switched in the step 309 to connect the ATTs 4a to 4d to the optical receiving modules to be tested 7e to 7h in the second constant temperature oven 6b. Next, in the step 310, the high frequency switches 8a to 8h are controlled to connect the optical receiving modules to be tested 7e to 7h in the second constant temperature oven 6b to the ERDs 9a to 9d. Thereafter, in the step 311, measurement of the optical receiving modules to be tested 7e to 7h accommodated in the second constant temperature oven 6b is started and the temperature of the first constant temperature oven 6a is changed to T2 from T1 in the step 312.

The tests can be continued without any intermission, namely time loss of the test due to temperature change of the constant temperature oven can be eliminated by constructing the testing system of this embodiment and controlling the system as explained above. As a result, the time required for the tests can be shortened. Moreover, since the expensive PPG 2 and ERDs 9a to 9d can be operated more effectively than the related art, the cost required for tests can also be lowered.

When the temperature changing time is n times the measuring time, the number of constant temperature ovens can be increased up to n by shifting the measurement start time of each constant temperature oven as long as the time required for the measurement.

Next, measurement of the minimum receiving sensitivity will be explained with reference to FIG. 6.

FIG. 6 is a characteristic diagram showing a code error rate of the minimum receiving sensitivity. In this figure, a receiving power is plotted on the horizontal axis, while a code error rate on the vertical axis. As the receiving power to be supplied to the optical receiving module to be tested is reduced, the code error rate becomes large. Therefore, the minimum receiving power, namely the minimum receiving sensitivity must be measured to obtain the predetermined code error rate. The minimum receiving sensitivity shows a graph shown in FIG. 6 by measuring the code error rate at the measuring time under the condition that the receiving power is varied. For example, when the specification of the minimum receiving sensitivity is 10⁻¹⁵, estimation is possible by extending the straight line (or curve) of the graph. Even in this condition, the time of 6.7 minutes is required for the measurement of the 2.5 Gpbs optical receiving module to be tested up to the specification of 10⁻¹¹, the time of 1.7 minutes is required for the measurement of 10 Gbps module and moreover the time of 10 times will be required for the measurement up to the specification of 10⁻¹². Since the time is required for the test of the optical receiving modules as explained above, improvement of the throughput is essential.

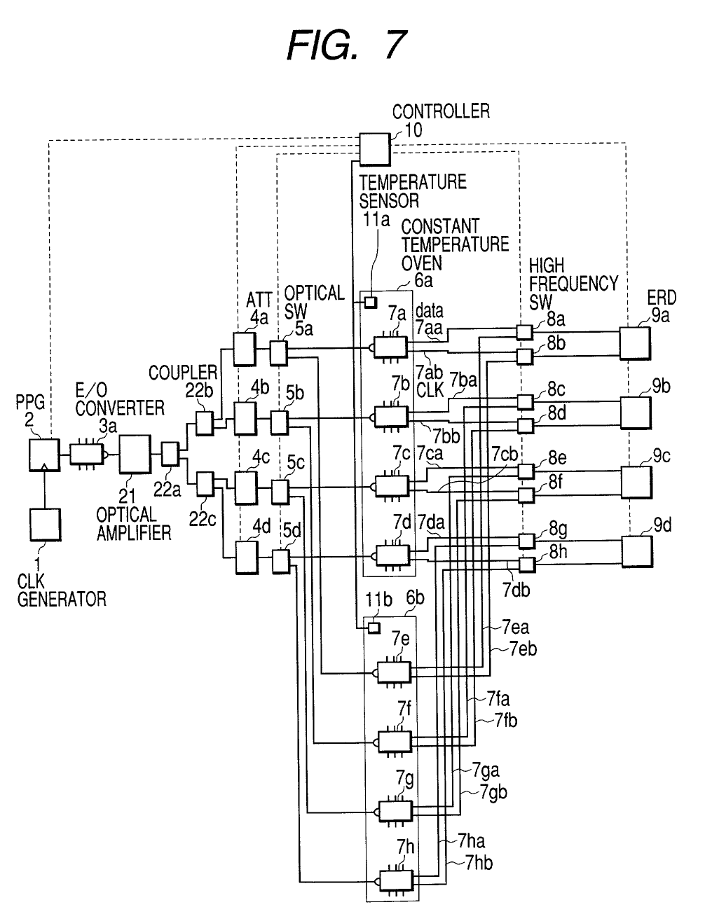

Next, the second embodiment of the testing system of the optical receiving module to be tested of the present invention will then be explained with reference to FIG. 7.

FIG. 7 is a block diagram showing the second embodiment of the testing system of the optical receiving module to be tested of the present invention. In this embodiment, difference from the first embodiment is that only one E/O converter 3a (standard optical transmitting module) is used, an output of the E/O converter 3a is amplified by an optical amplifier 21, the optical signal is divided with photo-couplers 22a, 22b, 22c and the divided optical signals are then inputted to the ATTs 4a to 4d but the other constructions are identical to that of FIG. 1. The structural elements like those of FIG. 1 are designated with the like reference numerals and the same explanation will be omitted here. In this second embodiment, amount of attenuation by the photo-couplers 22a to 22c is, for example, 6 dB and this amount of attenuation is compensated with the optical amplifier 21.

In FIG. 1, it is difficult to prepare the E/O converters (standard optical transmitting modules) 3a to 3d having the equal characteristics in order to set the correlation among the measuring systems on the occasion of testing in parallel a plurality of modules. In this embodiment, since only one E/O converter 3a is used, it is no longer required to consider characteristic difference among four E/O converters 3a to 3d as shown in FIG. 1. Since only one E/O converter 3a is used, only one variable wavelength light source is necessary for the SX test and an optical amplifier for ASE noise may be used in common, the cost of the testing system can be lowered.

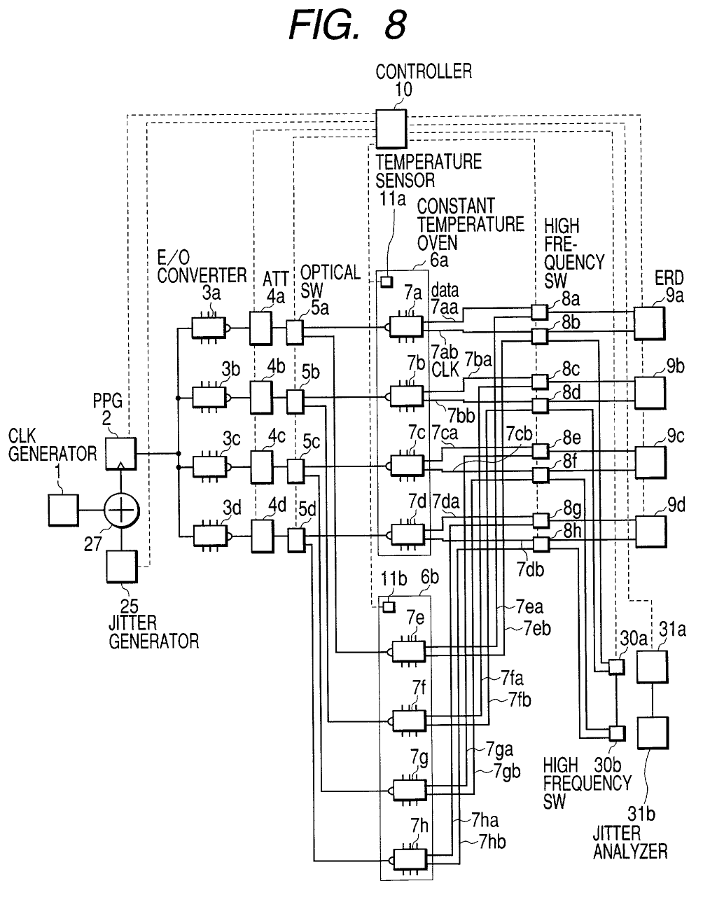

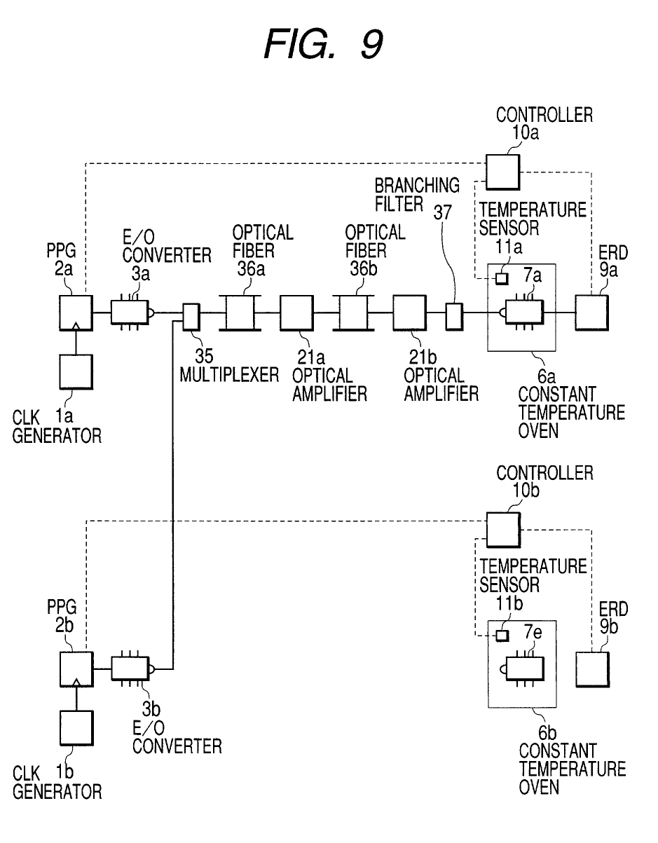

Next, a third embodiment will be explained with reference to FIG. 8.

FIG. 8 is a block diagram showing the third embodiment of the optical receiving module testing system of the present invention. In the embodiment shown in the figure, a jigger generator 25 is provided additionally in comparison with the embodiment of FIG. 1 and an output of the jitter generator 25 and the clock CLK from the CLK generator 1 are inputted to an adder 27 to change the phase of clock and give jitter to the signals. This clock (CLK) is supplied to the PPG 2 to generate a pulse pattern. Moreover, a high frequency switch 8b selects and outputs only one of the clocks 7ab, 7eb from the optical receiving modules to be tested 7a, 7e, while a high frequency switch 8d selects and outputs only one of the clocks 7bb, 7fb from the optical receiving modules to be tested 7b, 7f. Here, the outputs of these high frequency switches 8b, 8d are inputted to a high frequency switch 30 to select any one of clocks. The selected clock is then inputted to a jitter analyzer 31a. Thereby, it is judged whether a PLL of the optical receiving module to be tested operates normally even when the jitter exists or not. In addition, a high frequency switch 8f selects and outputs any one of the clocks 7cb, 7gb from the optical receiving modules to be tested 7c, 7g and a high frequency switch 8h selects and outputs any one of the clocks 7db, 7hb from the optical receiving modules to be tested 7d, 7h. Here, the outputs of these high frequency switches 8f, 8h are inputted to the high frequency switch 30b to select any one of the clocks. The selected clock is then inputted to a jitter analyzer 31b. Thereby, it is judged whether the PLL of the optical receiving module to be tested operates normally even when the jitter exists or not.

As explained above, the performance for jitter can be tested in this embodiment. Moreover, in this embodiment, the testing cost can be lowered by alternately testing, for example, the optical receiving modules to be tested 7a, 7b or the optical receiving modules to be tested 7c, 7d using two units of ERDs than that required when four units of ERDs 9a to 9d are used because the jitter analyzers 31a, 31b to be used for jitter generation and jitter transfer test are expensive but the testing time can be shortened.

An embodiment of the testing system in which an optical beam outputted from the E/O converter is caused to pass through an optical fiber will be explained with reference to FIG. 9.

FIG. 9 is a block diagram showing a fourth embodiment of the optical receiving module testing system of the present invention. In this embodiment, the PPGs 2a, 2b are respectively controlled with outputs of the CLK generators 1a, 1b to generate a pulse pattern, wavelengths of the outputs of the E/O converters 3a, 3b are respectively changed to λ1, λ2 and are then inputted to a multiplexer 35, and an output of the multiplexer 35 is then transmitted under the condition which is similar to that in the actual embodiment through an optical fiber 36a, an optical amplifier 21a, an optical fiber 36b and an optical amplifier 21b. Thereafter, the optical signal is branched with a branching filter 37 and is then supplied to the optical receiving modules to be tested 7a, 7e accommodated within the first and second constant temperature ovens 6a, 6b. In FIG. 9, only the optical receiving modules to be tested 7a, 7e are illustrated in the first and second constant temperature ovens 6a, 6b, but it is also possible, as shown in FIG. 1, to accommodate the optical receiving modules to be tested 7a to 7d within the first constant temperature oven 6a and to accommodate the optical receiving modules to be tested 7e to 7h within the second constant temperature oven 6b.

In this fourth embodiment, optical fibers 36a, 36b, optical amplifiers 21a, 21b are used in place of the ATTs 4a to 4d of FIG. 1. When the optical signals passes through the optical fibers 36a, 36b and optical amplifiers 21a, 21b, the waveform thereof is distorted but it is judged here whether the necessary code error rate can be assured even when the waveform is distorted or not. Therefore, as the optical fiber, the fiber in the length of 100 km, 200 km, 400 km is used. On the occasion of conducting the transmission test of several hundreds of km, the cost of optical fiber and optical amplifier becomes very expensive and the testing apparatus requires a larger area. Therefore, optical fiber and optical amplifier are used in common by giving difference to the wavelengths of the E/O converters 3a, 3b. Thereby, cost can be lowered and the testing apparatus can also be reduced in size.

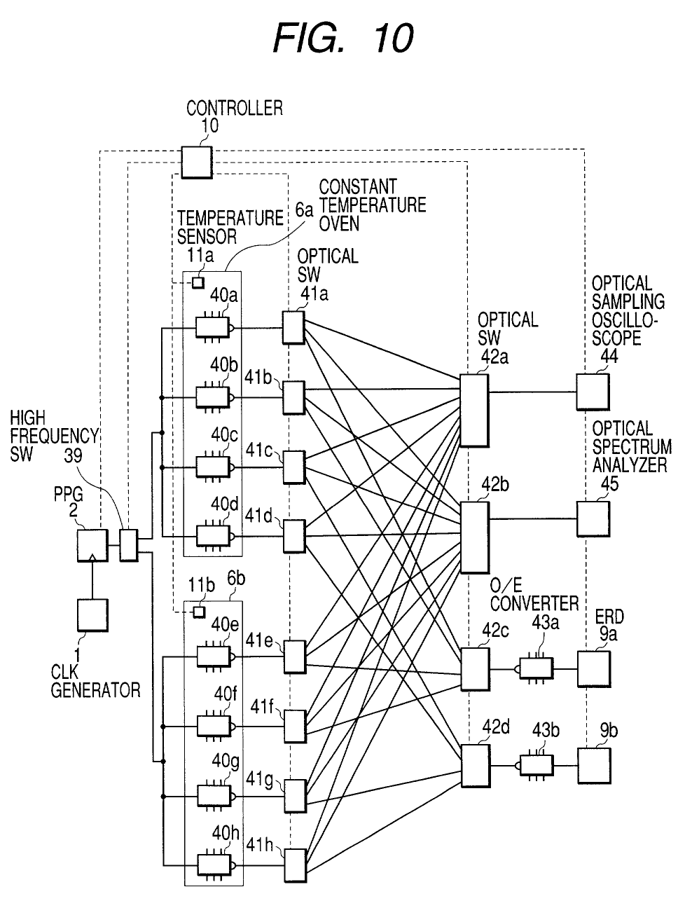

Next, an optical transmitting module testing system will be explained with reference to FIG. 10.

FIG. 10 is a block diagram showing a first embodiment of the optical transmitting module testing system of the present invention. In the optical transmitting module testing system indicated in the embodiment of the figure, one PPG (pulse pattern generator) 2, two ERDs (error detectors) 9a, 9b, one optical sampling oscilloscope 44, one optical spectrum analyzer 45 and two constant temperature ovens 6a, 6b are provided and temperature change of the second constant temperature oven 6b or exchange of the optical transmitting modules to be tested 40e to 40h can be realized while the four optical transmitting modules to be tested 40a to 40d are tested in the first constant temperature oven 6a.

In order to conduct the tests by the optical sampling oscilloscope 44 and one optical spectrum analyzer 45 in addition to the tests by the ERDs 9a, 9b, outputs from the optical transmitting modules to be tested 40a, 40b, 403e, 40f are respectively inputted to optical switches 42a, 42b, 42c with the optical switches 41a, 41b, 41e, 41f, while outputs from the optical transmitting modules to be tested 40c, 40d, 40g, 40h are respectively inputted to the optical switches 42a, 42b, 42d with the optical switches 41c, 41d, 41g, 41h. An output of the optical switch 42 is inputted to the optical sampling oscilloscope 44, an output of the optical switch 42b is inputted to the optical spectrum analyzer 45, an optical output of the optical switch 42c is inputted to the ERD 9a via the O/E converter 43a to convert an optical signal to an electrical signal and an optical output of the optical switch 42d is converted to an electrical signal via the O/E converter 43b and is then inputted to the ERD 9b.

The optical sampling oscilloscope 44 provides a window for eye-pattern to test whether the signal crosses the window or not. Namely, the optical sampling oscilloscope 44 executes the mask test. Moreover, it tests a power ratio in the bright and dark areas in the waveform of the optical signal, namely, conducts the test of extinction ratio. Moreover, optical spectrum analyzer 45 tests whether a ratio of the power of the main wavelength and the power of side mode is higher than the specified value or not.

In this embodiment, while the four optical receiving modules to be tested within the first constant temperature oven 6a are tested, temperature change of the second constant temperature oven 6b or exchange of the optical receiving modules to be tested is conducted and thereby measurements of optical waveform, optical spectrum and code error rate can be realized in parallel by switching the respective measuring instruments.

As explained above, the throughput of testing can be improved by conducting in parallel the measurements. Moreover, for the code error rate which requires a longer time, the ERDs 9a, 9b are used in parallel in order to improve the throughput and the other measurements are conducted by selectively using, through the switching operation of the optical switch, the optical receiving module to be tested which is not used for the measurement of code error rate in the constant temperature oven.

Here, it is also possible to add a jitter analyzer for the other measurement, for example, for the measurement of jitter. Moreover, the optical transmitting module testing system of this embodiment may also be used for the test of LD module which is only a component of the optical transmitting module and a modulation module in which LD and external modulation element are mounted.

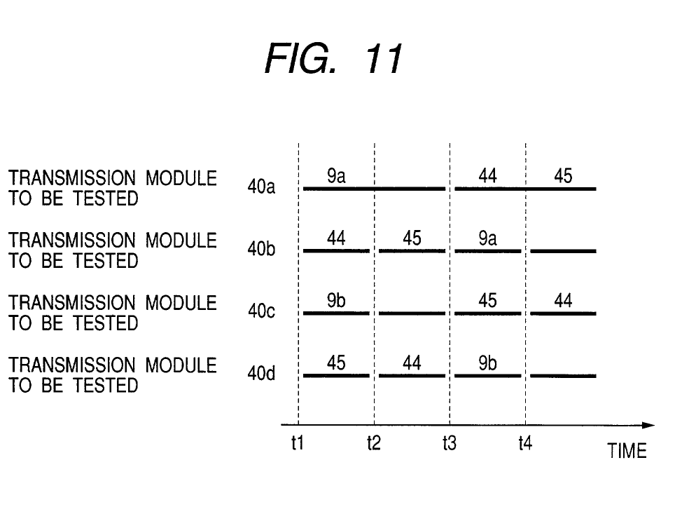

The testing procedures of the optical transmitting module tester in the embodiment of FIG. 10 will be explained with reference to FIG. 11.

FIG. 11 is a schematic diagram for explaining the testing procedures of the optical transmitting module to be tested. In this figure, time is plotted on the horizontal axis, while the optical transmitting modules to be tested 40a, 40b, 40c, 40d within the first constant temperature oven 6a on the vertical axis. The reference numerals of this figure designate the construction elements of FIG. 10.

FIG. 11 suggests that during the period from the time t1 to time t2, the optical transmitting module to be tested 40a is tested with the ERD 9a, while the optical transmitting module to be tested 40b is tested with the optical sampling oscilloscope 44, the optical transmitting module to be tested 40c is tested with the ERD 9b, and the optical transmitting module to be tested 40d is tested with the optical spectrum analyzer 45.

As is obvious from FIG. 11, the optical transmitting module to be tested 40a is tested with the ERD 9a during the period from the time t2 to time t3, also tested with the optical sampling oscilloscope 44 during the period from the time t3 to time t4 and tested with the optical spectrum analyzer 45 from the time t4. The optical transmitting module to be tested 40b is tested with the optical spectrum analyzer 45 during the period from the time t2 to time t3 and is tested with the ERD 9a from the time t3. The optical transmitting module to be tested 40c is tested with the ERD 9b during the period from the time t2 to time t3 and is also tested with the optical spectrum analyzer 45 during the period from the time t3 to time t4 and tested with the optical sampling oscilloscope 44 from the time t4. The optical transmitting module to be tested 40d is tested with the optical sampling oscilloscope 44 during the period from the time t2 to time t3 and is also tested with the ERD 9b from the time t3. Therefore, the optical transmitting module to be tested can be tested effectively.

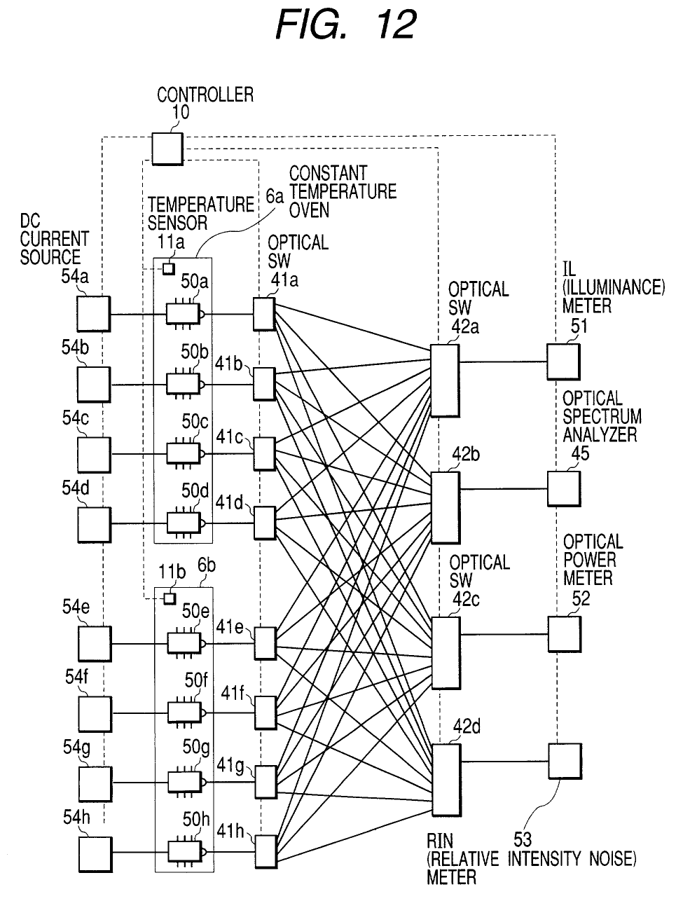

Next, the testing system of the LD module to be tested will then be explained with reference to FIG. 12.

FIG. 12 is a block diagram showing a first embodiment of the LD module testing system of the present invention. In this figure, DC currents from the DC current sources 54a to 54d are supplied to the LD modules to be tested 50a to 50d accommodated within the first constant temperature oven 6a, while DC currents from the DC current sources 54e to 54h are supplied to the LD modules to be tested 50e to 50h accommodated within the second constant temperature oven 6b. Outputs from the LD modules to be tested 50a to 50h are respectively supplied to the optical switches 41a to 41h. Outputs from the optical switches 41a to 41h are supplied to the optical switches 42a to 42d. An output of the optical switch 42a has been selected from the outputs of the optical switches 41a to 41h and this output is supplied to an IL meter 51 to measure an optical power for the current.

Moreover, an output of the optical switch 42b has been selected from the outputs of optical switches 41a to 41h and this output is supplied to the optical spectrum analyzer 45 to test whether a difference between the main mode and side mode is higher than the predetermined value or not. In addition, an output from the optical switch 42c has been selected from the outputs of optical switches 41a to 41h and this output is supplied to an optical power meter 52 in order to measure the DC distinction ratio. Moreover, an output from the optical switch 42d has been selected from the outputs of optical switches 41a to 41h and this output is supplied to a RIN meter 53 in order to test whether an optical output is higher than the specified value or not for noise level.

In this embodiment, when the four LD module to be tested within the first constant temperature oven are tested, temperature change of the second constant temperature oven 6b or exchange of the LD modules to be tested is conducted and the measurements of DC distinction ratio and RIN are also conducted using the IL meter, optical spectrum meter and optical power meter. In this embodiment, the optical switches 41a to 41h and 42a to 42d may be replaced with automatic insertion of the connectors by a robot.

As explained above, according to the present invention, the modules to be tested are accommodated within a plurality of constant temperature ovens and the modules to be tested accommodated within each constant temperature oven can be tested at different times. Therefore, the apparatuses required for the testing system such as PPG, ERD, optical sampling oscilloscope, optical spectrum analyzer, IL meter, optical power meter and RIN meter can be used effectively. Particularly, the number of units to be installed can be reduced by effectively operating the expensive apparatuses such as PPG and ERD.

As explained above, according to the present invention, many modules to be tested can be tested effectively.

The invention may be embodied in other specific forms without departing from the spirit or essential characteristics thereof. The present embodiment is therefore to be considered in all respects as illustrative and not restrictive, the scope of the invention being indicated by the appended rather than by the foregoing description and all changes which come within the meaning and range of equivalency of the claims are therefore intended to be embraced therein.

What is claimed is:

1. An optical module testing method comprising the steps of:
accommodating a first module to be tested within a first constant temperature oven;
accommodating a second module to be tested within a second constant temperature oven; and
testing said first module to be tested accommodates within said first constant temperature oven and said second module to be tested accommodated within said second constant temperature oven through the switching operation.

2. An optical module testing method according to claim 1, wherein said first and second modules to be tested are optical receiving modules and said testing is conducted using an error detector.

3. An optical module testing method according to claim 1, wherein said first and second modules to be tested are optical transmitting modules and said testing is conducted using any one of optical sampling oscilloscope, optical spectrum analyzer and error detector.

4. An optical module testing method according to claim 1, wherein said first and second modules to be tested are LD modules and said testing is conducted using any one of IL meter, optical spectrum analyzer, optical power meter and RIN meter.

5. An optical module testing method comprising the steps of:
generating a pulse pattern of electrical signal based on a clock;
converting said pulse pattern to an optical signal pattern;
attenuating the pulse pattern converted to said optical signal pattern;
supplying selectively said attenuated pulse pattern to a first receiving module to be tested accommodated within a first constant temperature oven and a second optical receiving module to be tested accommodated within a second constant temperature oven; and
testing a code error rate by switching said first optical receiving module to be tested and said second optical receiving module to be tested.

6. An optical module testing method according to claim 5, further comprising a step for testing the characteristic for jitter.

7. An optical module testing system comprising:
a first constant temperature oven;
a first module to be tested accommodated within said first constant temperature oven;
a second constant temperature oven;
a second module to be tested accommodated within said second constant temperature oven;
a switch for selecting said first module to be tested and said second module to be tested; and
a measuring instrument used for testing said first and second modules to be tested.

8. An optical module testing system according to claim 7, wherein said first and second modules to be tested are optical receiving modules and said measuring instrument is an error detector.

9. An optical module testing system according to claim 7, wherein said first and second modules to be tested are optical transmitting modules and said measuring instrument is one or more instruments selected from optical sampling oscilloscope, optical spectrum analyzer and error detector.

10. An optical module testing system according to claim 7, wherein said first and second modules to be tested are LD modules and said testing is conducted using at least one or more instruments selected from IL meter, optical spectrum analyzer, optical power meter and RIN meter.

11. An optical module testing system comprising:
a pulse pattern generator to generate a pulse pattern of electric signal based on a clock;
E/O converters for converting said pulse pattern to an optical signal pattern;
attenuators for attenuating the converted optical pulse pattern;
a first constant temperature oven;
a second constant temperature oven;
first optical receiving modules to be tested accommodated within said first constant temperature oven;
second optical receiving modules to be tested accommodated within said second constant temperature oven;
switches for selectively supplying outputs of said attenuators to said first optical receiving modules to be tested and said second optical receiving modules to be tested;
error detectors; and
switches for selectively supplying the signals to said first optical receiving modules to be tested and the second optical receiving modules to be tested.

12. An optical module testing system according to claim 11, further comprising a jitter analyzer.
